(19) United States
(12) Patent Application Publication
(10) Pub. No.: US 2005/0180038 A1
(43) Pub. Date: Aug. 18, 2005

(54) Data backup system, method, and program

(75) Inventors: Masayuki Chikashige, Tokyo (JP); Yohji Kuwahara, Machida-Shi (JP); Rika Noguchi, Yokohama-Shi (JP); Tetsuya Yoshida, Yokohama-Shi (JP)

Correspondence Address: DILLION & YUDELL, LLP, 8911 N CAPITAL OF TEXAS HWY, SUITE 2110, AUSTIN, TX, 78759, US

(73) Assignees: INTERNATIONAL BUSINESS MACHINES CORPORATION (IBM), ARMONK, NY (US); ADVANCED APPLICATION CORPORATION (AAC)

(21) Appl. No.: 10/999,511

(22) Filed: Nov. 30, 2004

(30) Foreign Application Priority Data
Dec. 1, 2003 (JP) JP-2003-401740

(51) Int. Cl. G11B 5/00

(52) U.S. Cl. 360/1

(57) ABSTRACT

A system, method, and computer program product for copying data to one or more recording media devices. In one embodiment, the method includes a step of specifying a data set group consisting of multiple, individually identified data sets within a task control table. The data set group specification preferably includes listing multiple data set identifiers each corresponding to one of the multiple data sets in a specified sequence within the task control table. Each of n mutually unique processing task identifiers are assigned within the task control table to a first n of the data sets in the specified sequence. The processing task identifiers correspond to one or more processing tasks having instructions for copying an assigned data set to a recording media device. The method further includes executing the processing tasks in accordance with the data set identifier sequence within the task control table.

### PRIORITY CLAIM

This application claims priority of Japanese Patent Application No. 2003-401740, attorney docket no. JP920030290JP1 filed on Dec. 1, 2003.

### BACKGROUND OF THE INVENTION

1. Technical Field

The present invention relates to a device, system and method for backing up a data set recorded on a recording medium such as a hard disk to an alternative storage or recording medium such as a magnetic tape.

2. Description of the Related Art

In addition to processing information, data processing systems such as computers, include storage/recording media such as hard disk drives for storing/recording data. Given the dependence of computers and application programs on various stored data, a recording medium failure such as a hard disk failure which results in loss of data may have serious consequences to the user. For this reason, particularly valuable or important data is typically stored on backup storage media such as magnetic tape as well as being stored for access by runtime applications on the hard disk or otherwise.

Such a backup is performed, for example, by copying the hard disk content as-is (image copy) in units of a data set (file), which is a specified group of data. To back up multiple data sets onto a single output medium, stack processing is performed. Stack processing involves recording the backups of each of the multiple individually specified data sets on the output medium in turn (i.e. in a specified sequence) and thereby curb the number of the output media.

For example, to backup four data sets of DS1, DS2, DS3 and DS4 to a single tape or other backup storage medium, in the foregoing specified numerically increasing order, stack processing is performed to record the image copies of DS1, DS2, DS3 and DS4 on the tape in this sequential order.

When the number of backup storage media devices, such as magnetic tapes, is limited to one, processing time efficiency is naturally limited due to the need to sequentially process a greater number of data sets or files during backup.

When multiple backup storage media devices are available, various methods may be used to assign each data set to be backed up to a destination backup device. For example, and assuming two backup tapes, tape1 and tape2, are simultaneously available to backup the foregoing described data sets DS1, DS2, DS3, and DS4, DS1 and DS3 may be assigned to tape 1 while DS2 and DS4 are assigned to backup tape2. The backup copy process for copying DS1 to tape1 and DS2 to tape2 may therefore be performed as well as the copy process or DS3 and DS4, thereby reducing the backup processing time from that required for the foregoing described serial backup process using a single backup medium device.

An exemplary problem with the parallel backup processing technique occurs, for example, when the time required for backup processing an image copy of DS2 to tape2 is longer than the time required for backup processing of the image copies of both DS1 and DS3 together. Namely, this condition results in a loss of parallel backup processing efficiency. More specifically, even if, continuing with the preceding example, tape1 is released by finishing backups of DS1 and DS3, the image copy process of DS4 is not commenced until the backup processing of DS2 has concluded.

From the foregoing, it can be appreciated that a need exists for a device, system, and method for managing data backup processing between one or more data sets and one or more prospective backup devices that maximizes parallel processing efficiency with minimal overhead equipment and control processing. The present invention addresses this and other needs unresolved by the prior art.

### SUMMARY OF THE INVENTION

A system, method, and computer program product for copying data to one or more recording media devices are disclosed herein. In one embodiment, the method includes a step of specifying a data set group consisting of multiple, individually identified data sets within a task control table. The data set group specification preferably includes listing multiple data set identifiers each corresponding to one of the multiple data sets in a specified sequence within the task control table. Each of n mutually unique processing task identifiers are assigned within the task control table to a first n of the data sets in the specified sequence. The processing task identifiers correspond to one or more processing tasks having instructions for copying an assigned data set to a recording media device. The method further includes executing the processing tasks in accordance with the data set identifier sequence within the task control table.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram depicting a data backup system in accordance with a preferred embodiment of the present invention.

FIG. 2 is a flowchart illustrating steps performed as part of a controlling task in accordance with a preferred embodiment.

FIG. 3 is a flowchart depicting steps performed as part of a processing task in accordance with one embodiment of the present invention.

FIG. 4A illustrates an exemplary instruction utilized to initiate a controlling task in accordance with a preferred embodiment.

FIG. 4B depicts an exemplary description for defining data sets to be included in a data set group in accordance with a preferred embodiment.

FIG. 5A is a table diagram depicting the contents of a task control table in accordance with one embodiment of the present invention.

FIG. 5B is a high-level block diagram illustrating a backup system in accordance with the embodiment shown in FIG. 5A.

FIG. 6A is a table diagram depicting the contents of a task control table in accordance with an alternate embodiment of the present invention.

FIG. 6B is a high-level block diagram illustrating a backup system in accordance with the embodiment shown in FIG. 6A.

FIG. 7A is a table diagram depicting the contents of a task control table in accordance with an alternate embodiment of the present invention.

FIG. 7B is a high-level block diagram illustrating a backup system in accordance with the embodiment shown in FIG. 7A.

FIGS. 8A and 8B are a high-level block diagrams depicting completion of the backup process in accordance with the present invention.

### DETAILED DESCRIPTION OF ILLUSTRATIVE EMBODIMENT(S)

Having the general aim of maximizing time and resource allocation and efficiency in a data backup process, the present invention is generally directed to a device, system, method and computer program product whereby one or more data sets within a data set group are backed up and also stacked and recorded on a predetermined number of tapes. Conventional controlling procedures have proved inadequate for backing up and recording multiple data sets in parallel on a single backup medium such as a magnetic tape. The data backup device according to the present invention comprises one or more so-called “processing tasks” that are managed and coordinated as set forth in further detail below by the control of a “controlling task.” As utilized herein a “processing task” may comprise any combination of computer implemented steps such as may be performed by a conventional data processing system. A processing task is characterized as a set of steps, instructions or commands that may be stored on a computer-readable medium, for performing a specified subset of data backup tasks. In support of processing tasks, the present invention includes computer-based executing means for executing one or more processing tasks. Execution of a single “processing task” preferably includes selecting and assigning one ore more data set(s) from among multiple data sets within a data set group to be sequentially backed up as part of the specified processing task. Following selection and assignment, the one or more data sets are recorded to one or more destination backup storage devices.

As utilized herein, a “controlling task” may comprises any combination of computer-implemented steps such as may be performed by a conventional data processing system. A controlling task may therefore be characterized as a set of steps, instructions or commands that may be stored on a computer-readable medium, for coordinating and dynamically managing the data backup tasks performed in accordance with the processing task(s). The present invention employs computer-based program execution means for executing a controlling task that determines the sequence, order, and/or termination point of the processing task(s) in question. The controlling task also preferably determines and assigns a “starting data set” that is the first data set within a given data set group to be selected by a respective processing task and its associated destination output device. The controlling task further comprises electronic and/or program instruction means for invoking one or more processing tasks.

The present invention is further directed to a data backup method for performing a backup process of the data sets within one or more specified data groups in a combined sequential manner in association with each processing task. The data backup method includes the steps performed in accordance with the controlling task in which data set to be first backed up by each processing task and a destination device for each processing task is determined. The method further comprises invoking multiple processing tasks, wherein each of the invoked processing tasks is assigned to a specified destination device.

The present invention is further directed to a computer program product for implementing the foregoing controlling tasks and processing tasks. The program product of the present invention includes computer-readable instructions stored on a computer storage medium that may be computer executed to effectuate selection and assignment of individual data sets from among multiple data sets within a data set group to be backed up, interleaved with steps of backing up the data set to destination devices individually assigned to each processor task. In addition, a first-selected data set to be first processed as part of each processor task as well as the identity of the specified processing-task assigned destination device are identified prior to performing the backup processing task functions.

The program product of the present invention may implement the controlling tasks for initializing and dynamically managing multiple, sequentially determined and executed processing tasks in parallel. To this end, the program product of the invention includes computer-executable program instructions, that when executed by a computer, result in invoking multiple processing tasks, and enabling each of the invoked processing tasks to recognize the data set to be first backed up and also to recognize an assigned destination device associated with each processing task.

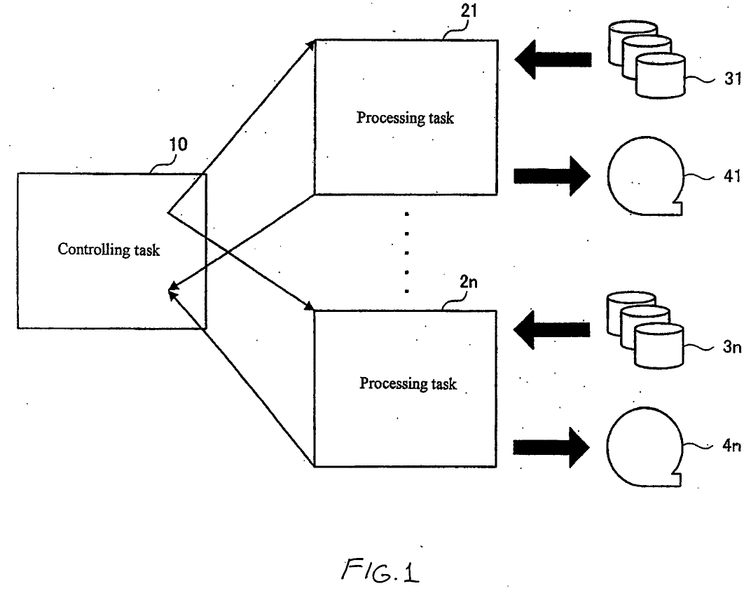

FIG. 1 is a high-level block diagram depicting a data backup system in accordance with a preferred embodiment of the present invention. The system shown in FIG. 1 includes a diagrammatic illustration of the general relationships among a controlling task 10, processing tasks 21-2n, data sets 31-3n, and destination devices, specified as output media devices 41-4n. Controlling task 10 comprises a process and electronic and/or computer program means for implementing the same, that generates a task control table (hereafter, referred to as a “TCT”) to be accessed and referenced by processing tasks 21 to 2n and stored in a memory (not shown) to effectuate invocation of each processing task. Upon invocation, each processing task receives and processes TCT entry information as described in further detail below.

As explained in further detail below, processing tasks 21 to 2n utilize assignment information in TCT entries to determine which of data sets 31 to 3n to read and which of output media 41 to 4n to write to in association with each processing task. The number of processing tasks n is not a specific fixed number but may take any value pre-determined or specified by a user.

Data sets 31 to 3n generally comprise collections of data stored/recorded on a hard disk that are to be backed up in accordance with the system and method disclosed herein. The data sets 31 to 3n may be included in an IMS (Information Management System) for example, and may be considered or designated as encompassing data sets grouped by functional objects. In the depicted embodiment, the data set processed by a processing task 2k (k=1, 2, . . . , n) is correspondingly designated as a data set 3k for ease and convenience of reference. It should be noted, however, that the assignment of a given data set to a given processing task is dynamically determined and is therefore generally not predetermined.

Output media 41 to 4n generally comprise data storage or memory devices (e.g. magnetic tapes, disks, other magnetic or optical storage media, etc.) to which data sets 31 to 3n are written during the backup procedure. In a preferred embodiment, a given output medium device 4k (k=1, 2, . . . , n) is pre-assigned to a given processing task 2k which consequently directs its data set backup procedure to the assigned output medium device 4k.

Regarding the hardware configuration of a computer for executing controlling task 10 and processing tasks 21 to 2n, a general-purpose or specialized computer or data processing platform may be employed. Such a data processing platform preferably includes a central processing unit (CPU) and a main memory which are connected to an auxiliary storage via a bus. Here, it is assumed that the auxiliary storage is the hard disk, flexible disk, MO (Magneto Optical disk), CD-ROM or magnetic tape or the like.

The auxiliary storage preferably includes electronic and/or computer program means for implementing the functions of controlling task 10 and processing tasks 21 to 2n. More specifically, a provided CPU reads the computer programs to the main memory and executes them so as to implement the functions of controlling task 10 and processing tasks 21 to 2n respectively. Regarding the computer program means for implementing the function of the processing tasks 21 to 2n, a single computer program preferably provides instructions for implementing each processing tasks 21 to 2n (rather than each of processing tasks 21 to 2n having a dedicated program). The processing task program for implementing processing tasks 21 to 2n is preferably executed over the n instances of processing tasks 21 to 2n. The computer program for implementing the function of the processing tasks 21 to 2n may also include instructions and data for implementing the function of controlling task 10.

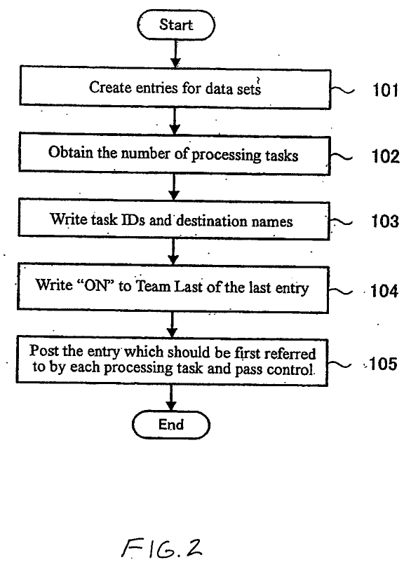

FIG. 2 is a flowchart illustrating steps performed as part of a controlling task, such as controlling task 10, in accordance with a preferred embodiment. Controlling task 10 generates a TCT that is referenced by processing tasks 21 to 2n, and which contains entry information referenced during processing task initialization. As described in further detail below, the generated TCT associates identification data with the data sets to be backed up. The identification data includes, data set identifier(s) and destination (output media) device(s) identifier(s) each corresponding to a specified processing task identifier. The identification data further includes a “Team Last” identifier indicating the last data set to be processed during the backup procedure described by the generated TCT. Controlling task 10 thus determines the data set processing order by setting the order of the data sets within the TCT in a specified sequence terminating with the data set designated “Team Last.”

The procedure for constructing the TCT, including the foregoing identification data is described as follows. First, controlling task 10 determines the data sets to be backed up and writes data set identifiers corresponding to each of the determined data sets (data set names for instance) as the initial entries in the TCT (step 101). Next, controlling task 10 obtains the number of processing tasks to be started (referred to as n) (step 102).

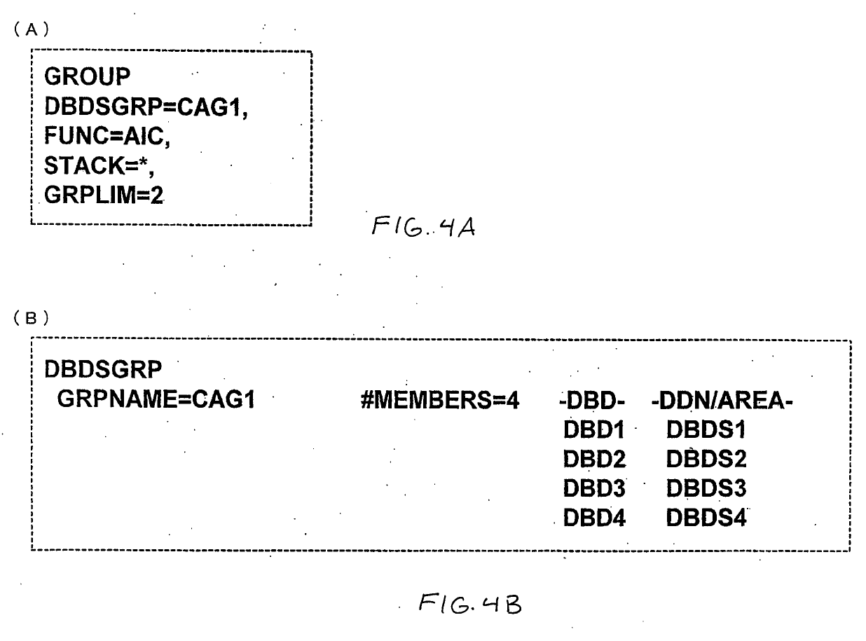

The entries in the TCT as defined by data set identifiers are processing by controlling task 10 as follows. Controlling task 10 examines the n slots and determines and writes processing task identifier data (a task ID for example) identifying the processing task to which the data set is assigned. From the determined processing task, controlling task 10 writes output media identifier data (a destination device name for example) identifying the destination device that is being (or has been) assigned to each of the respective processing tasks (step 103). An “ON” flag is set by controlling task 10 at the “Team Last” entry of the designated last data set to be processed (step 104). After generating the TCT, controlling task 10 posts the TCT entry or entries which is/are to be referenced first by the processing tasks 21 to 2n, and the processing tasks are started (step 105). In a preferred embodiment, the foregoing TCT generation procedure, as performed by controlling task 10, is initiated and supported by the exemplary start instruction depicted in FIG. 4A and the exemplary data set group description depicted in FIG. 4B.

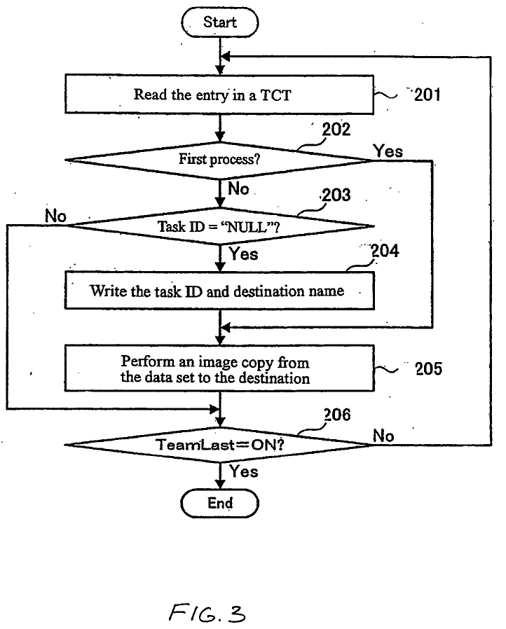

The operation of processing tasks 21 to 2n is depicted and described with reference to FIG. 3. As all the processing tasks 21 to 2n operate based on the same or similar logic, the following exemplary description of the operation of processing task 20 is understood to apply to one or more of processing tasks 21 to 2n. First, processing task 20 reads the entry information from the TCT posted by controlling task 10 (step 201). Next, processing task 20 determines whether or not the data set process described by a particular TCT entry is the first data set to be processed by processing task 20 (step 202). It is possible to determine whether or not it is the first process by providing a counter for counting a loop of the steps 201 to 206 and checking that the counter is at an initial value, for example.

If determined to be the first process, processing task 20 reads the data set for the entry and performs an image copy of the content of the data set identified in the entry to the output media device named by the destination name specified in the entry (step 205). In an initial data set backup process, processing task 20 recognizes its own task ID and the destination to be used for backups performed by processing task 20. If determined not to be the first data set backup process, processing task 20 determines whether or not the task ID for the entry is “NULL” (step 203).

In the case where the task ID is not “NULL,” the process proceeds to step 206. A determination at step 203 that the task ID is “NULL” indicates the data set for the entry has not been assigned a processing task and, processing task 20, as the next available processing task, is assigned to process the data set for the entry. Consequently, processing task 20 sets up the task ID corresponding to itself for the data set as well as the pre-assigned destination name determined from the first process (step 204). Processing task 20 then reads the data set for the entry and performs the image copy to the assigned destination device (step 205). Lastly, processing task 20 determines whether or not “ON” is set at the “Team Last” (step 206). If “ON” is set, it finishes the process. If “ON” is not set, it returns to the step 201 and continues the process.

FIG. 4A illustrates an exemplary instruction utilized to initiate a controlling task, such as controlling task 10, in accordance with a preferred embodiment. “DBDSGRP” is the description for specifying a group of the data sets to be backed up. In FIG. 4A, a group “CAG1” is specified as the group of the data sets to be backed up.

“FUNC” is a description for specifying a backup method. In the case in which “FUNC=IC” is specified, an alternate data set backup management procedure is used. That is, the method of performing the backup by sequentially processing the data sets to be backed up is adopted. If, however, “FUNC=AIC” is specified, the method disclosed herein is adopted as the data backup management technique.

In the depicted embodiment, “STACK” is a description for specifying the destination(s) to be utilized in the backup process. For explicitly specifying a destination, “STACK=STK1,“may be used for example. “STACK=*” is utilized for specifying only the number of destinations without explicitly identifying the destination(s) as shown in this embodiment.

“GRPLIM” is a description specifying the number of the processing tasks to be started (and the number of the output media to be used). As depicted in FIG. 4A, two processing tasks are specified to by started.

FIG. 4B depicts an exemplary description for defining data sets to be included in a data set group such as that specified in the exemplary controlling task start instruction shown in FIG. 4A. As depicted in FIG. 4B, the group generally comprises multiple DBs bundled for each application program, business unit and operational form, and one data set or a plurality of data sets are included in each of the plurality of DBs. In FIG. 4B, “DBD1,” “DBD2,” “DBD3” and “DBD4” described below “-DBD-” indicate DB names included in a group “CAG1.” “DBDS1,” “DBDS2,” “DBDS3” and “DBDS4” described below “-DDN/AREA-,” indicate data set names corresponding to the DBs.

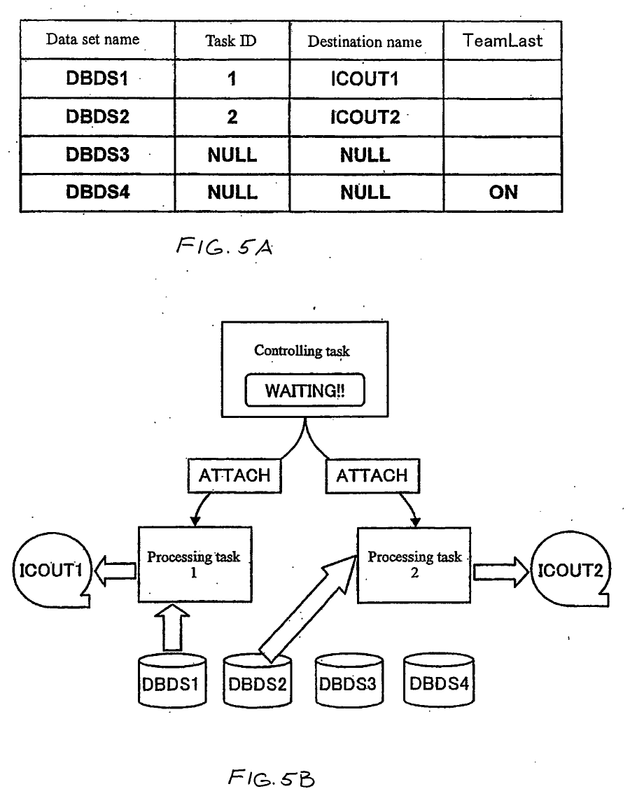

Consistent with the foregoing definitions, the operations of this embodiment will be described with reference to FIGS. 5A and 5B in conjunction with FIG. 2. FIG. 5A is a table diagram depicting the contents of an exemplary TCT and FIG. 5B is a high-level block diagram illustrating a backup system in accordance with the embodiment shown in FIG. 5A.

First, controlling task 10 performs the process depicted in FIG. 2 to generate the TCT shown in FIG. 5A. More specifically, controlling task 10 refers to “DBDSGRP” in definition information in FIG. 4A and recognizes that a backup subject is the data set group “CAG1.” Controlling task 10 then refers to the definition information in FIG. 4B and recognizes that the data sets included in the group “CAG1” comprise “DBDS1,” “DBDS2,” “DBDS3” and “DBDS4.” As depicted at step 101, controlling task 10 responds by writing “DBDS1,” “DBDS2,” “DBDS3” and “DBDS4” as the data set names, thereby generating four entries in the TCT.

Next, as shown at step 102, controlling task 10 refers to “GRPLIM” in the definition information in FIG. 4A and thereby recognizes that the number of the processing tasks to be started is two. The two tasks to be started in the depicted embodiment are processing tasks 1 and 2. The task ID of processing task 1 is “1,” and the destination used and associated in the TCT with processing task 1 is “ICOUT1.” The task ID of the processing task 2 is “2,” and the destination used by the processing task 2 is “ICOUT2.”

Proceeding as depicted at step 103, controlling task 10 examines the first two entries of the TCT and writes the task ID “1” and the destination name “ICOUT1” to “DBDS1,” and also writes the task ID “2” and the destination name “ICOUT2” to “DBDS2.” At this point, “DBDS3” and “DBDS4” are “NULL” because the processing tasks for handling them and the destinations are undecided. As shown at step 104, controlling task 10 sets “Team Last” for “DBDS4” at “ON.”

At step 105, controlling task 10 posts the data backup processing entry information in the TCT which are to be initially processed in accordance with the respectively assigned processing tasks 1 and 2 and passes control to the electronic and/or program means that implement processing tasks 1 and 2. More specifically, controlling task 10 posts a first entry of the TCT to be referenced/processed and attaches the processing task 1, and posts a second entry of the TCT to be referenced/processed and attaches the processing task 2. After passing control to processing tasks 1 and 2, controlling task 10 waits until the processing tasks 1 and 2 are finished.

Responsive to the being passed control from controlling task 10, processing tasks 1 and 2 each perform the data backup processing illustrated in FIG. 3. To this end, processing task 1 reads the first entry of the TCT in the step 201, and having determined the entry to represent the first data set to be processed by processing task 1 (step 202), proceeds to step 205 at which point it reads the data content represented by “DBDS1” and outputs it to be recorded on the output media device represented by “ICOUT1.” Similarly, processing task 2 reads the second entry of the TCT in the step 201, and having determined the entry to represent the first data set to be processed by processing task 2 (step 202), proceeds to step 205 at which point it reads the data content represented by “DBDS2” and output it to be recorded on the output media device represented by “ICOUT2.” Referring to FIG. 5B, with the data backup system is in a state in which processing tasks 1 and 2 are communicatively coupled to controlling task 10, processing task 1 reads “DBDS1” and outputs it to “ICOUT1” and processing task 2 reads “DBDS2” and outputs it to “ICOUT2.”

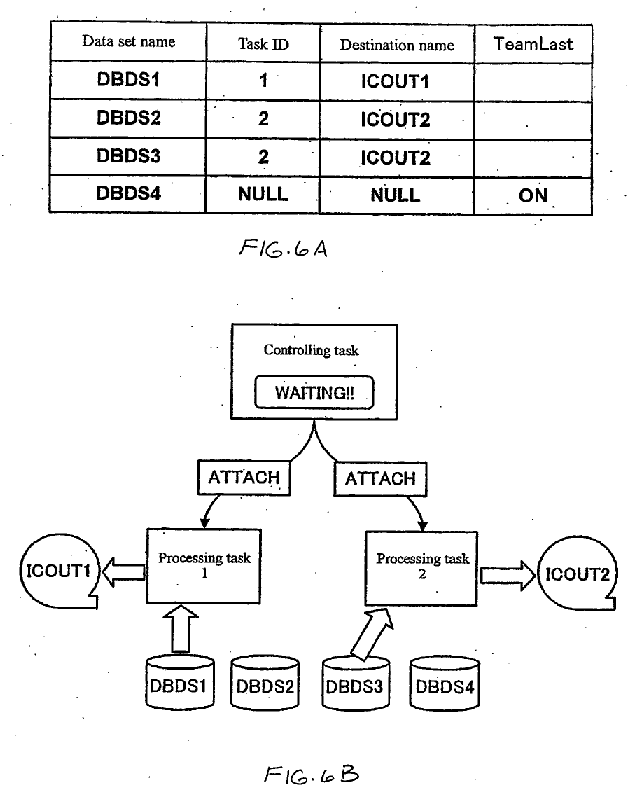

Next, and referring to FIGS. 6A and 6B in conjunction with the foregoing figures, it is assumed that processing task 2 has finished the backup process of “DBDS2” while processing task 1 continues the backup process of “DBDS1.” In this case, processing task 2 searches for the data set to be processed next. The data set to be processed next is the one for which task ID and destination name are “NULL” or an equivalent default setting indicating that a processing task has not been assigned to the data set entry. More specifically, responsive to determining that “Team Last” is not set “ON” for “DBDS2” at step 206, processing task 2 proceeds to step 201 so as to read the entry for “DBDS3.” Further determining the entry not to be the first data set backup process (step 202), processing task 2 proceeds to step 203 to determine whether or not the task ID is set to “NULL.” Having determined the task ID is set to “NULL,” processing task 2 proceeds to step 204 depicting writing the task ID “2” and the destination name “ICOUT2” to the data set entry as shown in FIG. 6A, prompting processing task 2 to read the data content represented by “DBDS3” and output it to be recorded on the output media device represented by “ICOUT2” as shown at step 205. FIG. 6B depicts the state of the data backup system in which processing task 1 reads “DBDS1” and outputs it to “ICOUT1” and the processing task 2 reads “DBDS3” and outputs it to “ICOUT2” while the processing tasks 1 and 2 remain attached to the controlling task 10.

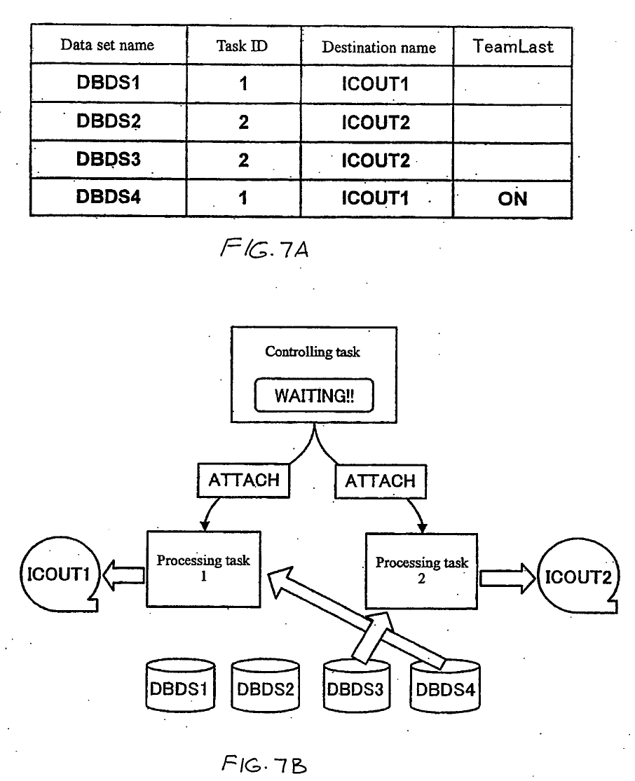

Next, as depicted in the alternate embodiment shown with reference to FIGS. 7A and 7B in conjunction with the foregoing figures, it is assumed that processing task 1 has finished the backup process of “DBDS1” while processing task 2 continues the backup process of “DBDS3.” In this case, the processing task 1 searches for the data set to be processed next. The data set to be processed next is the one for which task ID and destination name are “NULL.” More specifically, responsive to determining that “Team Last” is not set “ON” for “DBDS1” at step 206, the processing task 1 proceeds to step 201 so as to read the entry for “DBDS2.” Further determining the entry not to be the first data set backup process (step 202), processing task 1 proceeds to step 203 to determine whether or not the task ID for the data set entry is set to “NULL.” Responsive to determining the task ID is not set to “NULL,” processing task 1 proceeds to step 206 to determine whether or not the “Team Last” or equivalent “last data set entry” is set “ON” or otherwise asserted. Next, in response to “Team Last” for “DBDS2” not being set “ON,” processing task 1 proceeds to step 201 so as to read the entry for “DBDS3.” Determining “DBDS3” not to be the first data set processing entry (step 202), processing task 1 proceeds to step 203 to determine whether or not the task ID for the entry is set to “NULL,” and if not continues as depicted at step 206. Responsive to determining “Team Last” for “DBDS3” is not set “ON,” processing task 1 proceeds as shown at step 201 with the entry for “DBDS4” being read. In response to determining “DBDS4” not to be the first data set process entry (step 202), processing task 1 continues as illustrated at step 203. If the task ID for the “DBDS4” entry is determined to be “NULL,” processing task 1 proceeds to step 204. As shown in FIG. 7A, processing task 1 responds by writing “1” as the task ID and “ICOUT1” as the destination name for the data set entry. As illustrated at step 205, processing task 1 reads the data content represented by “DBDS4” and outputs it to “ICOUT1.”

FIG. 7B depicts a state of the data backup system in which the processing task 1 reads “DBDS4” and outputs it to “ICOUT1” and the processing task 2 reads “DBDS3” and outputs it to “ICOUT2” while the processing tasks 1 and 2 remain attached to the controlling task 10. It is further assumed that processing task 1 has finished the backup process of “DBDS4” while processing task 2 continues the backup process of “DBDS3.” In this case, the processing task 1 has no data set to be processed next, and so it posts its own end processing to the controlling task 10 and disappears after finishing the processing. To be more specific, as “Team Last” for “DBDS4” is determined to be “ON” in the step 206, processing task 1 finishing the processing as-is.

Continuing with the preceding example, when processing task 2 has finished the backup process of “DBDS3,” the processing task 2 has no data set to be processed next, and it responds by posting its own end processing to the controlling task 10 and disappears after finishing the processing. To be more specific, as “Team Last” for “DBDS3” is determined not to be “ON” in the step 206, the processing task 2 moves on to the step 201 to read the entry for “DBDS4.” And it is determined not to be the first process in the step 202 and so it moves on to the step 203. As the task ID is determined not to be “NULL,” processing task 2 proceeds to step 206, at which point “Team Last” for “DBDS4” is determined to be set “ON,” and processing task 2 finishes the processing as-is.

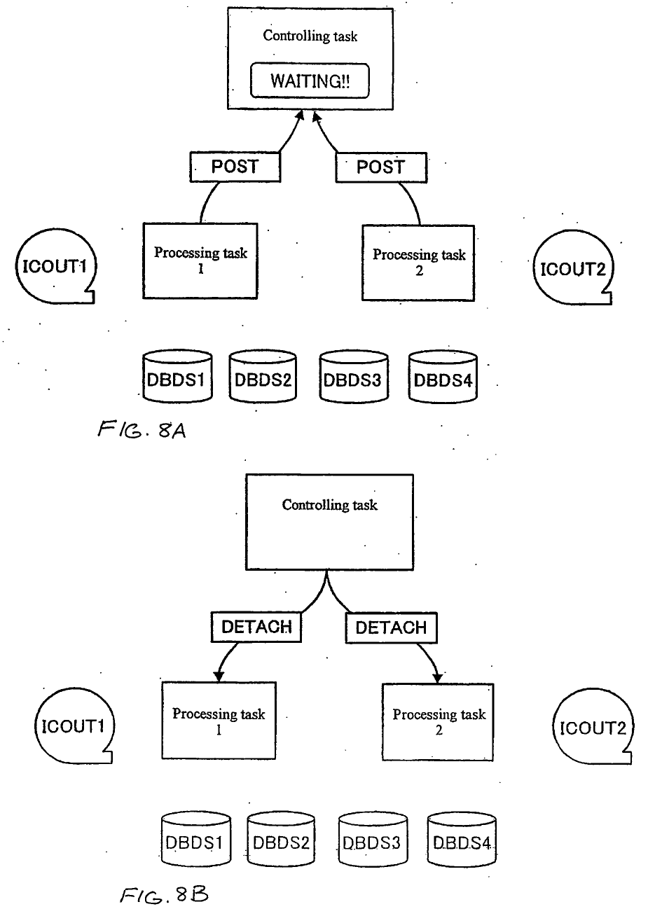

Next, the data backup system is configured in the manner illustrated at FIG. 8A, wherein processing tasks 1 and 2 report their respective processing completions to controlling task 10 by “POST.” Controlling task 10 confirms that all the processing tasks included in the TCT have been completed and also performs the end processing. More specifically, controlling task 10 detaches each processing task as shown in FIG. 8B. In accordance with the above-described processing, the backups of “DBDS1” and “DBDS4” are recorded at the destination “ICOUT1” in this order, and the backups of “DBDS2” and “DBDS3” are recorded at the destination “ICOUT2” in this order.

According to the foregoing embodiments, a specified number of the processing tasks for backing up the plurality of data sets to an output medium are started, and each of the processing tasks dynamically determines the data set to be backed up so as to reduce total data backup processing time. Referring to the foregoing example, the backups of “DBDS1” and “DBDS2” are processed in parallel first, and their respective outputs are recorded at “ICOUT1” and “ICOUT2.” When one of the backups is finished thereafter, the backup process of “DBDS3” is started.

According to this embodiment, controlling task 10 prepares a TCT having entries associated on a per data set basis and containing the data set information for each of the total number of data sets. Controlling task 10 starts the specified number of processing tasks, where only the information on the entry of the data set to be first processed by each processing task and the destination for each processing task is passed from controlling task 10 to each processing task. As for the data sets to be processed by each processing task, a processing task searches the TCT created by controlling task 10 after finishing the processing of the data set first specified by the controlling task 10 so as to obtain the information for the data sets yet to be processed. The destination for each processing task is uniquely determined so that the destination for the data sets processed by the same processing task is the same tape where they will be stacked. Such a process is repeated until there is no unprocessed data set.

As for the method of controlling the processing tasks performed in parallel, the controlling task may pass the information to each processing task each time the data set is backed up. In this case, the controlling task performs the process while monitoring each processing task. More specifically, the controlling task waits for the completion of each processing task while performing time control with a timer, and enters a monitoring mode again by passing the information on the next data set on finishing one process. In the case of performing such a process, the following problems may occur.

Firstly, there is a problem that the controlling task does not completely wait but performs the process for monitoring at certain time intervals while monitoring the processing task so that it takes the processing time.

Secondly, there is a problem that it takes the processing time for receiving and passing parameters and control between the controlling task and the processing task so that it takes time to move from the process for one data set to the process for the next data set.

Thirdly, there is a problem that the control becomes complicated as to which processing task writes which data set to which destination.

The foregoing notwithstanding, the problems solved by the method of the foregoing embodiment are as follows.

The controlling task waits for the processing of all data sets to be completed after starting the processing tasks so that the controlling task consumes no processing time during that period.

The processing task, once started, searches for the next data set to be processed by it immediately upon finishing the process of one data set so that the time required to move from the process of one data set to the process of the next data set is reduced.

As the destination for one processing task is one location, it is possible to easily control a relationship between the data set to be processed and the destination so as to simplify the instructions.

As described above, it is possible, by adopting the controlling method of this embodiment, to reduce the time for the backup process and cut CPU time.

According to this embodiment, the specified number of processing tasks are started and each of the processing tasks automatically determines which data set should be stacked and stored on which tape. Therefore, it is possible, with a simple specification, to process the plurality of data sets in parallel so as to stack and record them on a specified number of tapes. For instance, as to the above concrete example, two tapes are set up as the destinations by specifying “GRPLIM=2.”

There is also the advantage that the processing time and storage are curbed by allocating the tapes at copy destinations and reusing the processing tasks to minimize the processing time.

This embodiment uses the TCT associating the data set name, task ID, destination name and “Team Last” with one another. However, a configuration of the TCT is not limited to this. It is not always necessary to provide the task ID if each processing task can determine the data set to be first backed up and the destination for the backup. In the case where the data set to be backed up is determined, each processing task writes the task ID and destination name so that the. data set will not be selected by another processing task. It is also possible, however, to store the information indicating whether or not the processing task for backing up each data set has been determined apart from the task ID and destination name. Furthermore, it is also possible not to provide “Team Last” if separate means for knowing the last entry of the TCT can be secured.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

1. A method for copying data to one or more recording media devices, said method comprising:
specifying a data set group that comprises a plurality of individually identified data sets within a task control table, said specifying a data set group including listing a plurality of data set identifiers corresponding to said plurality of data sets in a specified sequence within said task control table;
assigning each of n mutually unique processing task identifiers to a first n of said data sets in said specified sequence, said processing task identifiers corresponding to one or more processing tasks having instructions for copying an assigned data set to a recording media device; and
executing said processing tasks in accordance with the data set identifier sequence within said task control table.

2. The method of claim 1, wherein said specifying a data set group further comprises generating data set specific entries within said task control table.

3. The method of claim 2, wherein for each of said assigned processing task identifiers, said executing said processing tasks comprises:
reading a data set entry;
determining a whether the data set entry has an extant processing task identifier assignment; and
responsive to determining that the data set entry has no extant processing task identifier assignment:
writing the task identifier of said processing task to the data set entry; and
copying to a recording media device the data content corresponding to the data set identifier specified in the data set entry.

4. The method of claim 2, further comprising posting n data set entries to be initially referenced and processed by said processing tasks.

5. The method of claim 1, wherein each of said n processing tasks is uniquely associated with one of n recording media devices.

6. The method of claim 5, wherein said assigning each of n processing tasks to a first n of said data sets further comprises associating each of said recording media devices with a data set in accordance with said processing tasks assignments.

7. The method of claim 1, further comprising specifying within said task control table a last entry flag that designates a data set to be last processed by said processing tasks.

8. A computer program product for copying data to one or more recording media devices, said computer program product including computer-executable instructions for performing a method comprising:
specifying a data set group that comprises a plurality of individually identified data sets within a task control table, said specifying a data set group including listing a plurality of data set identifiers corresponding to said plurality of data sets in a specified sequence within said task control table;
assigning each of n mutually unique processing task identifiers to a first n of said data sets in said specified sequence, said processing task identifiers corresponding to one or more processing tasks having instructions for copying an assigned data set to a recording media device; and
executing said processing tasks in accordance with the data set identifier sequence within said task control table.

9. The program product of claim 8, wherein said specifying a data set group further comprises generating data set specific entries within said task control table.

10. The program product of claim 9, wherein for each of said assigned processing task identifiers, said executing said processing tasks comprises:
reading a data set entry;
determining a whether the data set entry has an extant processing task identifier assignment; and
responsive to determining that the data set entry has no extant processing task identifier assignment:
writing the task identifier of said processing task to the data set entry; and
copying to a recording media device the data content corresponding to the data set identifier specified in the data set entry.

11. The program product of claim 9, said method further comprising posting n data set entries to be initially referenced and processed by said processing tasks.

12. The program product of claim 8, wherein each of said n processing tasks is uniquely associated with one of n recording media devices.

13. The program product of claim 12, wherein said assigning each of n processing tasks to a first n of said data sets further comprises associating each of said recording media devices with a data set in accordance with said processing tasks assignments.

14. The program product of claim 8, said method further comprising specifying within said task control table a last entry flag that designates a data set to be last processed by said processing tasks.

15. A system for copying data to one or more recording media devices, said system comprising:
means for specifying a data set group that comprises a plurality of individually identified data sets within a task control table, said specifying a data set group including listing a plurality of data set identifiers corresponding to said plurality of data sets in a specified sequence within said task control table;
means for assigning each of n mutually unique processing task identifiers to a first n of said data sets in said specified sequence, said processing task identifiers corresponding to one or more processing tasks having instructions for copying an assigned data set to a recording media device; and
means for executing said processing tasks in accordance with the data set identifier sequence within said task control table.

16. The system of claim 15, wherein said means for specifying a data set group further comprises means for generating data set specific entries within said task control table.

17. The system of claim 16, wherein for each of said assigned processing task identifiers, said means for executing said processing tasks comprises:
means for reading a data set entry;
means for determining a whether the data set entry has an extant processing task identifier assignment; and
means responsive to determining that the data set entry has no extant processing task identifier assignment for:
writing the task identifier of said processing task to the data set entry; and
copying to a recording media device the data content corresponding to the data set identifier specified in the data set entry.

18. The system of claim 16, further comprising means for posting n data set entries to be initially referenced and processed by said processing tasks.

19. The system of claim 15, wherein each of said n processing tasks is uniquely associated with one of n recording media devices.

20. The system of claim 19, wherein said means for assigning each of n processing tasks to a first n of said data sets further comprises means for associating each of said recording media devices with a data set in accordance with said processing tasks assignments.
